(19) United States
(12) Patent Application Publication
(10) Pub. No.: US 2024/0430531 A1
(43) Pub. Date: Dec. 26, 2024

(54) Method for managing playback of multimedia content

(71) Applicant: ORANGE, Issy Les Moulineaux (FR)

(72) Inventors: Mathieu Rivoalen, CHATILLON CEDEX (FR); Hervé Marchand, CHATILLON CEDEX (FR)

(21) Appl. No.: 18/747,752

(22) Filed: Jun. 19, 2024

(30) Foreign Application Priority Data
Jun. 20, 2023 (FR) 2306356

(51) Int. Cl. H04N 21/472; H04N 21/431

(52) U.S. Cl. CPC H04N 21/47217; H04N 21/431

(57) ABSTRACT

A method for managing playback of multimedia content by a playback device equipped with a processor and with a content player including a plurality of playback functions. The available playback functions of the player vary over time.

### CROSS-REFERENCE TO RELATED APPLICATIONS

This Application claims priority to French Patent Application No. FR 2306356, Filed Jun. 20, 2023, the content of which is incorporated herein by reference in its entirety.

### TECHNICAL FIELD

The field of the disclosure is that of digital multimedia content, namely digital audio and/or video content, also called audiovisual content.

The disclosure very particularly relates to a method for managing playback of multimedia content by a playback device.

The expression “playback device” in particular means any device able to receive a multimedia stream, in particular in the form of chunks, for example a decoder, a mobile telephone, a tablet, etc., and to read the received stream, with a view to rendering it.

The content is for example live content, television on demand, video on demand, etc.

### BACKGROUND

There are, at the present time, many devices for playing back audiovisual content that allow a user to access multimedia content (television programs, video on demand (VoD), television on demand (Transactional Video on Demand, TVoD), etc.).

Current playback devices include one or more playback modules, also referred to as players below, capable of receiving digital content in the form of multimedia data and of requesting rendition thereof on a rendering device.

There are a number of types of content players that offer, via a menu rendered on a screen, functions related to the player such as display of a playback progress bar, display of commands such as play, pause, rewind (symbol <<) and fast forward (symbol >>), etc.) which are presented on a human-machine interface in menu form. Because of the diversity of these functions, and of the respective amounts of processor resource that they consume, at any given time a content player will be consuming a greater or lesser amount of processor resource (CPU load will also be referred to below).

Depending on the type of content to be played back and on the type of player, CPU load may become excessive. For example, at a given time, if the player comprises a menu with many functions in the process of being used-such as a progress bar, a fast-forward command in course of execution associated with rendition of thumbnails extracted from the content being played back, which thumbnails change over time to indicate a state of advance of the fast forward-all these functions in the process of being used consume processor resource and may therefore generate CPU overload, and if in addition the content being played back is rendered in the background simultaneously with the menu, thereby adding an additional CPU load dedicated to rendition of this video in the background, CPU load may sometimes get close to 90%. This overconsumption results in problems with rendition of the content (pixelation, slowdowns) or may even cause the content to cut out, this being completely unacceptable in terms of quality of service.

One or more exemplary aspects of the present disclosure aim to improve the situation.

### SUMMARY

According to one functional aspect, one subject of the disclosure is a method for managing playback of multimedia content by a playback device equipped with a processor and with a content player comprising a plurality of playback functions, characterized in that the available playback functions of the player vary over time.

According to an aspect of the present disclosure, the configuration of the player varies over time during playback of given content. This ability to make functions that consume a relatively large or small amount of processor resource available or unavailable during playback of given content makes it possible to control consumption of processor resource and therefore to avoid overloading this resource.

It will be noted that the expression “available function” means a datum representative of a piece of information and/or an executable command. As will be seen below, a piece of information is for example a display of a progress bar indicating progression of content playback; and a command is for example a command to play, pause, rewind, etc.

According to a first embodiment, a playback function being able to be rendered on a rendering device, only an available function is rendered on the screen. This first embodiment makes it possible to decrease the number of functions rendered on the screen to those that are available, thus facilitating, because of the reduction in the number of functions, selection of a function on a screen by a user.

According to a second embodiment, which may be implemented instead of or cumulatively with the preceding embodiment, the functions are rendered independently of their respective availability, and selection of unavailable functions is inhibited. For example, when the function is a piece of information rendered on a screen, said piece of information is frozen on the screen-for example, in the case of a progress bar displayed on a screen, the progress bar no longer indicates the progress of the playback; or when the function is a command able to be selected on the screen, the command, although rendered, cannot be selected and executed.

According to a third embodiment, which may be implemented instead of or cumulatively with the preceding ones, the availability of a function is dependent on a type of content to be played. This simple embodiment merely identifies the type of content (live content, video on demand, etc.) and selects the available functions, for example a player offering commands suitable for the content to be played; if the content is on-demand content, the selected available functions will be suitable for this type of content, i.e. a rewind or fast-forward function, a pause function, etc.

According to a fourth embodiment, which may be implemented instead of or cumulatively with the preceding ones, the availability of a function is dependent on an execution context associated with playback of the content.

According to a first variant of this fourth embodiment, the execution context includes display of a function-containing menu on a screen in addition to the content being rendered. Here, the function-containing menu and content are rendered simultaneously. Such a configuration sometimes leads to CPU overload. By virtue of this variant, when a menu and a content are rendered simultaneously, functions are automatically made unavailable in order to free up the processor resource and thus ensure undegraded rendition of the content.

According to a second variant of this fourth embodiment, the execution context is associated with a current amount of use of the processor resource. In this embodiment, a given CPU load may result in function availability or unavailability being triggered. For example, if a maximum CPU load is set at 80% (the amount could be expressed in a unit other than percent), if the current amount is 85%, certain functions are made unavailable in order to preclude a problem with CPU overload.

Since a plurality of functions are available, each consuming a relatively large or small amount of processor resource, this fourth embodiment and the associated variants make it possible to decrease CPU load, thus ensuring undegraded rendition of the content.

According to a fifth embodiment, which may be implemented instead of or cumulatively with the preceding ones, a function becomes available following activation of the function. In this embodiment, the availability of a function is based on a player instantiation.

According to a sixth embodiment, which may be implemented instead of or cumulatively with the preceding ones, the functions are activated or deactivated successively until a given amount of use of the processor resource is obtained. Availability is based on a principle that is simple to implement, and which consists in activating or deactivating the functions one after another and in checking whether the CPU load reaches a given value when this is done; as soon as the given CPU-load value is reached, the managing entity stops activating or deactivating functions. This embodiment avoids activation or deactivation of a plurality of functions at once, which might lead to unavailability of functions that could be useful.

According to one variant of the sixth embodiment, the functions are classified according to their respective consumption of processor resources, the successive activations or deactivations being carried out according to this classification until a given amount of use of the processor resource is obtained. In this sixth embodiment, the consumption of processor resource is estimated beforehand and classified hierarchically before subsequently being used for activation or deactivation purposes. This embodiment aims to reduce the consumption of the processor resource so that it is available for computing tasks other than the playback in progress.

According to one variant of the sixth embodiment, the functions are classified by preference, the successive activations or deactivations being carried out according to the classification. This embodiment makes it possible, when the processor resource is too busy, to deactivate functions in an order of preference, for example starting with the least preferred function. It will be understood that, despite a reduction in functions, the functions that will remain available will be functions classified among the most preferred ones. In contrast, if the number of functions is increasing, selection is in the order of preference, and therefore, for example, a preferred function is selected first.

According to one hardware aspect, the disclosure relates to an entity for managing playback of multimedia content by a playback device equipped with a processor and with a content player comprising a plurality of playback functions, characterized in that the processor is configured to make the available playback functions of the player vary over time during playback of the content.

According to another hardware aspect, the disclosure relates to a decoder comprising a managing entity such as defined above.

According to another hardware aspect, the disclosure relates to a computer program able to be implemented on an entity such as defined above, the program comprising code instructions that, when it is executed by a processor, carry out the steps of the selecting method that are defined above.

Lastly, according to another hardware aspect, the disclosure relates to a data medium on which at least one series of program-code instructions for executing a managing method such as defined above has been stored.

Such a recording medium may be any entity or device capable of storing the program. For example, the medium may comprise a storage means, such as a ROM, for example a CD-ROM or a microelectronic circuit ROM, or even a magnetic recording means, for example a USB key or a hard disk.

Furthermore, such a recording medium may be a transmissible medium such as an electrical or optical signal, which may be routed via an electrical or optical cable, by radio or by other means, such that the computer program that it contains is able to be executed remotely. The program according to an aspect of the present disclosure may in particular be downloaded from a network, for example the Internet.

Alternatively, the recording medium may be an integrated circuit into which the program is incorporated, the circuit being configured to execute or to be used in the execution of the abovementioned display control method.

### BRIEF DESCRIPTION OF THE DRAWINGS

The disclosure will be better understood on reading the following description, which is given by way of example and with reference to the appended drawings, in which:

FIG. 1 shows a computer system in which one example of embodiment of the disclosure is illustrated.

FIG. 2 is a simplified block diagram of the hardware structure of the playback device.

FIG. 3 illustrates one embodiment in which the available functions are dependent on processor load; this figure shows two states of the player at two separate times.

### DETAILED DESCRIPTION OF ONE EXAMPLE OF EMBODIMENT ILLUSTRATING THE DISCLOSURE

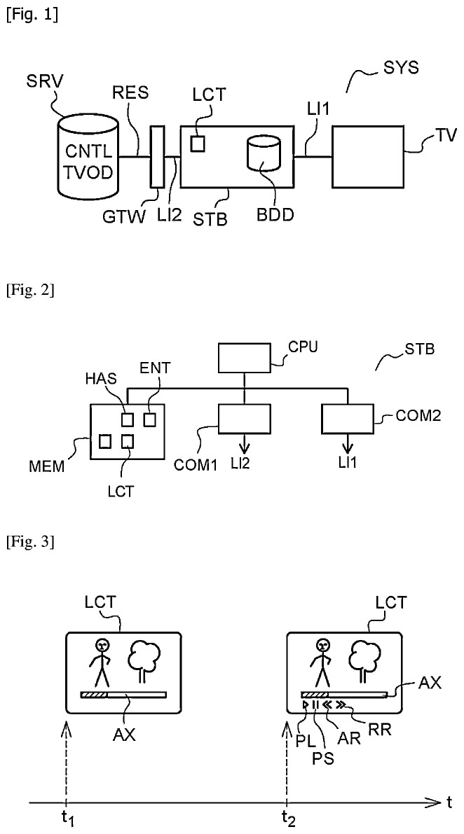

With reference to FIG. 1, the computer system SYS comprises a device STB for playing back a multimedia stream, for example a decoder connected to a rendering device TV. It will be noted here that the decoding playback device STB and the rendering device may form one and the same piece of equipment.

In the present example, the playback device STB is connected to a port of the rendering device TV via a wired link LI1 of HDMI type. This link could very well be wireless, a Wi-Fi link for example.

In the present example, the playback device STB is located in a local area network LAN managed by a residential gateway GTW.

In FIG. 1, the link between the playback device STB and the gateway has been referenced LI2.

The gateway GTW is able to communicate via a telecommunications network RES, such as a wide area network WAN known to those skilled in the art.

A digital content server SRV is in the present example connected to the wide area network RES. The content server SRV for example receives live digital television content channels CNTL from a television broadcaster (not shown) and/or videos on demand TVOD, and makes them available to client terminals and here to the playback device STB.

In the present example, the playback device STB is a client. In this client-server context, to exchange data between the client terminal STB and the content server SRV, the technique called HTTP adaptive streaming (HAS) is frequently used. This type of technique makes it possible in particular to offer the user a good content quality while taking into account variations in bandwidth that may occur on the link between the client terminal STB and the service gateway GTW, and/or between the gateway GTW and the content server SRV.

FIG. 2 shows an architecture of a playback device STB. This device STB comprises, in a conventional manner, memories MEM associated with a processor CPU. The memories may be read-only memories (ROMs) or random-access memories (RAMs) or indeed flash memories.

The decoder STB comprises what is referred to by the person skilled in the art as a buffer memory.

The decoder STB may transmit content to be rendered to the rendering device TV via a communication module COM2. This module COM2 is for example an HDMI link.

The decoder STB communicates with the gateway via an Ethernet module for wired local communication, or via a Wi-Fi radio module for wireless local communication. The module in question is referenced COM1 in FIG. 2.

In the present example, the playback device STB comprises a downloading module able to manage download in adaptive-streaming mode, and therefore able to request that content be streamed with one of the qualities proposed in a description file. The description file may be downloaded and stored for example in the memory MEM of the decoder STB or may be located outside the decoder STB.

Conventionally, as will be seen with reference to FIG. 3, given content of a channel may be encoded with various qualities, corresponding for example to various encoding bit rates. More generally, the term “quality” will be used to refer to a certain resolution of the digital content (spatial resolution, temporal resolution, quality level associated with the video and/or audio compression) with a certain encoding bit rate. Each quality level is itself divided, in the content server, into chunks.

In the present example, the system SYS further comprises an encoder and a description-file generator, which have also not been shown because they have no bearing on the present disclosure. The role of the encoder is to encode digital content in order to obtain a plurality of chunks and a plurality of representations for each chunk.

The adaptive-streaming technique will not be described in more detail as it has no bearing on the present disclosure.

It will also be noted here that the disclosure is not limited to adaptive-streaming mode; other modes may be used to implement aspects of the present disclosure, such as the IPTV mode (IPTV standing for Internet Protocol Television) which uses Internet technology to broadcast television programs.

The playback device STB further comprises a managing entity ENT, which is one subject of the disclosure, and the function of which will be explained below.

In the present example, the module for downloading in adaptive-streaming mode is included in the managing entity ENT.

The playback device STB also comprises a player LCT that is able to display a menu containing functions such as a play command, a rewind command (symbol <<), a pause command, etc.

The decoder STB may also comprise other modules such as a hard disk (not shown) for storing video chunks, etc.

In the present example, the playback device STB is able to communicate with the content server SRV with a view to receiving chunks of content (films, documentaries, advertisements, etc.).

The managing entity ENT comprises a playback module LCT, called the player in the present text, the function of which is to play back content received by the playback device STB. In the present example, the player LCT receives chunks, decodes them and requests rendition of the decoded chunks.

The player LCT in question comprises a menu with a plurality of functions related to playback. In the present example, certain functions have an influence on playback; others are informative and have no influence on playback, for example a progress bar providing information on the state of advance of the playback.

The expression “function having an influence on playback” for example means commands such as a command to play content, a rewind command (often symbolized by <<), a fast-forward command (>>), a command to stop playback, etc. The term “function” does not solely mean a command but also encompasses, for example, information rendered on the screen such as the current time, a progress bar representative of a state of advance of the playback of the current content, etc.

All of these functions consume processor resource when they are executed.

According to an aspect of the present disclosure, in order to better preclude consumption of this resource, the playback device, i.e. the managing entity ENT, manages function availability over time. In other words, the playback functions available at any given time vary over time. In this way, when one or more functions become unavailable, for example, the latter are no longer executable in the case of a function of command type.

In the present example, availability is managed by activating or deactivating functions. The ability to activate a function related to playback of content allows the player LCT to be instantiated at will and at any time, i.e. before playback of content or during playback of content.

FIG. 3 shows a view of a variation over time in the available functions of the player LCT.

Two times t1 and t2 have been shown in FIG. 3, to which times respective functional states of the player LCT correspond.

In the present example, at the time t1, the player LCT displays a menu MEN displaying, by way of function, merely a time axis AX showing the state of advance of the playback. This axis is an informative function.

In the present example, at another time t2, the player LCT activates other functions and displays the resulting menu displaying a plurality of activated functions, namely:
a time axis AX just like the first player and other executable functions, namely:
a button PL for starting playback if it has stopped;
a pause button PS;
a fast forward/rewind button AR/RR;
a display of an image associated with the current playback time.

In the present example, it will be assumed that the more activated functions the menu has, the higher the CPU load.

According to an aspect of the present disclosure, the managing entity ENT manages selection of the functions to be activated or deactivated of the player LCT.

The choice of the functions to be used will depend on an execution context associated with playback, and for example on the load on the processor resource and/or on a type of content to be played back. For example, if the current processor load is greater than 80%, only the axis AX is rendered; if the load is less than 80%, all functions are activated and are therefore available.

The steps may be as follows:

In a first step, the playback device STB requests access to live content, for example in adaptive-streaming mode in the way indicated above.

In the present example, in a second step, an entity ENT determines the type of content and selects functions suitable for playback of this type of content.

The menu and therefore the functions to be activated or deactivated may be determined by consulting a database BDD. In the present example, the database BDD indicates the functions to be activated and deactivated depending on the amount of use of the processor resource and on the type of content to be played back.

It will be seen below that activation and deactivation may occur:
per group of functions (in other words, a plurality of functions are activated or deactivated at the same time);
or function by function one after the other until a desired CPU load is reached.

The functions F1-F3 are considered to be possible functions for on-demand content TVOD. Let us assume that the functions F1 to F3 are as follows:
a first function F1 corresponding to the time axis AX just like the first player, and other functions, namely:
a second function F2 corresponding to the pause button PS;
a third function F3 corresponding to rewind button RR.

In the present example, the database BDD contains the following values:

| CPU/Type (Fn) | <80% | ≥80% |
|---|---|---|
| TVOD (F1, F2, F3) | F1, F2, F3 | F1 |

indicating that:
if the CPU load is less than 80% and the content is on-demand television content, all the functions F1 to F3 are available;
if the CPU load is greater than or equal to 80% and the content is on-demand television content, only function F1 is available.

According to a first embodiment, as indicated above, the functions are activated/deactivated per group of functions.

In a third step, the managing entity ENT identifies the selected content type CNTL, in the present example the on-demand content type TVOD.

Next, in a fourth step, the managing entity ENT obtains the CPU load at a time t. Let us assume that the CPU load is 85% at that time; in this case, the managing entity ENT detects that the CPU load is greater than the maximum load of 80% and activates only function F1. At this stage, a user cannot act on playback, for example by fast-forwarding playback, as the associated function F3 is deactivated.

It will be noted that, instead of the degree of use of the processor, the entity ENT may rely on other data such as the encoding rate of the received chunks to determine the functions to be activated and/or deactivated. Specifically, most of the time, the consumption of processor resource varies linearly with encoding rate.

In the present example, the entity ENT checks the load of the processor CPU very often, for example periodically every second.

It is assumed that, at a given subsequent time t, in a fifth step, the managing entity ENT detects that the CPU load has dropped to 40%. The managing entity ENT checks in the database which functions should be activated or deactivated with a load of 40%. Given the current configuration of the player, with the function F1 being activated, the managing entity ENT activates the group of functions F2 and F3. At this stage, the functions F1-F3 are activated.

As mentioned above, activation and deactivation may also be carried out function by function. For example, the functions F1 to F3 are activated or deactivated one after the other until a desired CPU load is achieved.

Thus, according to one variant, the functions Fn (n=1,2,3) in the database may be classified beforehand according to their respective consumption of processor resource when they are executed. The respective consumption of each of the functions may be obtained in tests carried out beforehand. In this way, when functions must be activated or deactivated one after the other, successive activations/deactivations are carried out in accordance with the established classification.

Returning to the preceding example, it is assumed for example that function F3, once executed, consumes more than function F2, which itself consumes more than function F1 when it is executed. In this configuration, when the CPU load is greater than 80%, the managing entity ENT starts by deactivating the function that would consume the most processor resource and obtains, after deactivation, a given CPU load.

There are two possible cases following deactivation:

Either the CPU load drops to less than 80%; in this case, the method then stops. At this stage, the functions F1 and F2 are activated and the function F3 is deactivated.

Or the CPU load is still greater than 80%; in this case, the managing entity ENT continues the deactivation and deactivates the second function F2 in order to decrease the CPU load. It is assumed that the CPU load drops to 45%, i.e. below the set threshold of 80%, as a result of this deactivation; in this case, the method then stops. At this stage, the function F1 is the only function activated.

Also, activating or deactivating a function may take a number of forms.

According to one variant, an available, and therefore activated, function is rendered on an interface and a deactivated function is not rendered. This variant reduces the number of functions rendered on a screen; the user experience can only be better.

According to another variant, an activated function is rendered on an interface, and a deactivated function is rendered on the interface but inhibited. This variant is advantageous in that it displays the deactivated functions despite the fact that they are deactivated; a user viewing the interface and frustrated at not being able to access all the functions may act on the CPU load by stopping programs being executed on the playback device STB and thus increase the number of functions available.

It will lastly be noted that the embodiments described above are based on a CPU load. However, other resources may be taken into account such as the battery resource.

It will finally be noted here that the term “module” or the term “entity” may correspond equally to a software component or to a hardware component or to a set of software and hardware components, a software component itself corresponding to one or more computer programs or subroutines or, more generally, to any element of a program able to implement a function or a set of functions such as described for the modules in question. In the same way, a hardware component corresponds to any element of a hardware assembly able to implement a function or a set of functions for the module in question (integrated circuit, chip card, memory card, etc.).

Although the present disclosure has been described with reference to one or more examples, workers skilled in the art will recognize that changes may be made in form and detail without departing from the scope of the disclosure and/or the appended claims.

1. A managing method comprising:
managing playback of multimedia content by a playback device equipped with a processor and with a content player comprising a plurality of playback functions, by making available playback functions of the plurality of playback functions of the player vary over time.

2. The managing method according to claim 1, wherein each of the plurality of playback functions is able to be rendered on a rendering device, and only an available function is rendered on the screen.

3. The managing method according to claim 1, wherein the plurality of playbeack functions are rendered independently of their respective availability, and selection of unavailable playback functions is inhibited.

4. The managing method according to claim 1, wherein the availability of a function of the plurality of playback functions is dependent on a type of content to be played back.

5. The managing method according to claim 1, wherein the availability of a function of the plurality of playback functions is dependent on a current amount of use of the processor as a resource.

6. The managing method according to claim 1, wherein a function of the plurality of playback functions becomes available following activation of the function.

7. The managing method according to claim 6, wherein the functions of the plurality of playback functions are activated or deactivated successively until a given amount of use of the processor as a resource is obtained.

8. The managing method according to claim 7, wherein the functions of the plurality of playback functions are classified according to their respective consumption of resources of the processor and wherein the successive activations or deactivations are carried out according to the classification.

9. The managing method according to claim 7, wherein the functions of the plurality of playback functions are classified by preference, and wherein the successive activations or deactivations are carried out according to the classification.

10. A managing entity for managing playback of multimedia content by a playback device comprising player comprising a plurality of playback functions, wherein the entity comprises:
at least one processor; and
at least one non-transitory computer readable medium comprising instructions stored thereon which when executed by the at least one processor configure the managing entity to make available playback functions of the player vary over time during playback of the content.

11. A decoder comprising the managing entity as defined in claim 10.

12. A non-transitory computer readable data medium on which at least one series of program-code instructions is stored for executing a managing method when the instructions are executed by at least one processor, wherein the managing method comprises:
managing playback of multimedia content by a playback device equipped with a processor and with a content player comprising a plurality of playback functions, by making available playback functions of the plurality of playback functions of the player vary over time.
